(19) United States
(12) Patent Application Publication
(10) Pub. No.: US 2026/0032570 A1
(43) Pub. Date: Jan. 29, 2026

(54) DYNAMIC NETWORK MANAGEMENT SYSTEM FOR WIRELESS DEVICES

(71) Applicant: T-Mobile USA, Inc., Bellevue, WA (US)

(72) Inventor: Vasu Krishnasami, Bellevue, WA (US)

(21) Appl. No.: 18/783,285

(22) Filed: Jul. 24, 2024

(51) Int. Cl. H04W 48/18; H04W 60/04; H04W 76/10

(52) U.S. Cl. CPC H04W 48/18; H04W 60/04; H04W 76/10

(57) ABSTRACT

The technology relates to a network management system that facilitates efficient operation of user devices on telecommunications networks. The network management system receives a network registration request from a wireless device to register the wireless device to a telecommunications network, where the wireless device is uniquely identified to differentiate between multiple devices. The system then extracts the identifier from the device and determines the device's compatibility with the network using this identifier. Based on this compatibility assessment, the network management system generates network preferences for the device. The preferences involve detecting available networks and prioritizing connections within this set based on device compatibility and predefined rules. Subsequently, the system automatically selects the most suitable network for the device and initiates the connection.

### BACKGROUND

Voice over New Radio (VoNR), also referred to as Voice over 5G or Vo5G, is a 5G high-speed wireless communication standard for mobile phones and data terminals, including Internet of Things (IoT) devices and wearables. As the successor to Voice over LTE (VOLTE), VoNR fully utilizes the 5G Standalone (SA) core. VOLTE, on the other hand, was the first technology to enable voice calls over LTE networks, shifting from traditional circuit-switched voice calls to packet-switched voice calls using the LTE infrastructure. VOLTE offers clearer voice quality and faster call setup times compared to 3G or 2G voice calls and enables simultaneous voice and data transmission, allowing users to browse the internet or use data services during a voice call.

When a wireless device requests to register to a network, the wireless device sends a registration request to the network's authentication and authorization systems. The request includes information such as the device's International Mobile Equipment Identity (IMEI), International Mobile Subscriber Identity (IMSI), and other identifying details. The network verifies the device's credentials and allocates resources for communication between the wireless device and the network.

### BRIEF DESCRIPTION OF THE DRAWINGS

Detailed descriptions of implementations of the present technology will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3A is a block diagram that illustrates a dynamic network management system used on relocated multiple devices that can implement aspects of the present technology.

FIG. 3B is a block diagram that illustrates a dynamic network management system used on multiple devices that can implement aspects of the present technology.

FIG. 4 is a block diagram that illustrates a dynamic network management system used on a single device that can implement aspects of the present technology.

FIG. 5 is a block diagram that illustrates a service profile for a device in a dynamic network management system that can implement aspects of the present technology.

FIG. 6 is a flowchart that illustrates a process performed by a dynamic network management system to prioritize networks.

FIG. 7 is a block diagram that illustrates an example of a computer system in which at least some operations described herein can be implemented.

The technologies described herein will become more apparent to those skilled in the art from studying the Detailed Description in conjunction with the drawings. Implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology can address the lack of control when connecting a device to a network. With the transition to 5G technology and the implementation of advanced calling features like Voice over New Radio (VoNR), a significant obstacle arises due to the varying capabilities of wireless devices and the lack of standardized protocols for managing these capabilities within network systems. While 5G performs with faster data speeds and lower latency, many devices currently in use lack compatibility with specific calling technologies like VoNR on 5G networks. Consequently, when users attempt to make calls using these devices, the users often fall back to utilizing older LTE technology, resulting in suboptimal call quality and overall network performance. The inconsistency not only diminishes the user experience but also poses challenges for network operators striving to deliver reliable and high-quality services. Network management systems lack efficient means to differentiate between devices capable of certain abilities (such as VoNR) on certain networks (such as 5G) and devices that are not, leading to inefficient network utilization and potentially disrupting users' communication experiences.

For example, in a scenario where a user in the United States, equipped with a smartphone lacking support for VoNR technology on 5G networks, would be unable to make calls on the 5G network, as it lacks the necessary VoNR capabilities. For example, incoming calls would be redirected to voicemail, as the network cannot deliver them to the device. The device remains unable to perform basic voice communication functions until the device moves into an area with LTE coverage or an overlapping coverage area that includes both 5G and LTE networks. Thus, the user experiences interruptions, dropped calls, and/or degraded call quality. Implementations of the technology described herein solve these and other problems.

The disclosed technology relates to dynamically managing network selections by prioritizing certain networks above other networks based on device compatibility. The network management system, in some implementations, receives a network registration request from a wireless device, where the wireless device is associated with an identifier (e.g., an International Mobile Equipment Identity (IMEI) identifier) such that the wireless device can be uniquely identified among other devices. The system then extracts the identifier from the device and determines the device's compatibility with the network using the identifier. Based on the compatibility assessment, the network management system generates network preferences for the device. The preferences involve detecting available networks and prioritizing connections within the set of available networks based on device compatibility and predefined rules. Subsequently, the system automatically selects the most suitable network for the device and initiates the connection.

In some implementations, the network management system creates a service profile for the wireless device that details the device's network preferences. Additionally, the network management system can modify the service profile based on any changes in device compatibilities or network preferences. In some implementations, the network management system is instructed to extract a Type Allocation Code (TAC) from the IMEI identifier of the wireless device and store the identifier in the service profile.

In some implementations, the network registration request is initially received, and the network management system prioritizes connections within the available networks. Subsequently, upon detecting a change in the set of available networks or device compatibilities, or upon receiving a second network registration request, the network management system generates new network preferences based on device compatibilities. The network management system then automatically selects a second network and initiates the connection between the wireless device and the chosen (e.g., first) network. In some implementations, the network management system maintains a set of records (e.g., a set of lists, a set of queues), including a set of allowed networks, a set of unauthorized networks, or a set of circumstantial networks, for an overall set of networks based on capabilities or historical performance. The network management system automatically selects the first network based on the network preferences of the wireless device and the set of records.

In some implementations, If there's no other network coverage available, the network management system can still allow the registration request to proceed. In some implementations, the network management system notifies the device via SMS or push notification that certain calls (e.g., calls besides emergency calls to 911), may not function in the current coverage area.

In some implementations, the device compatibilities of the wireless device encompass support for features such as Voice over New Radio (VoNR) or Voice over LTE (VOLTE). In some implementations, the network management system determines device compatibilities by querying a global database external to the network management system. The global database contains compatibility data for multiple wireless devices, including the wireless device in question.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

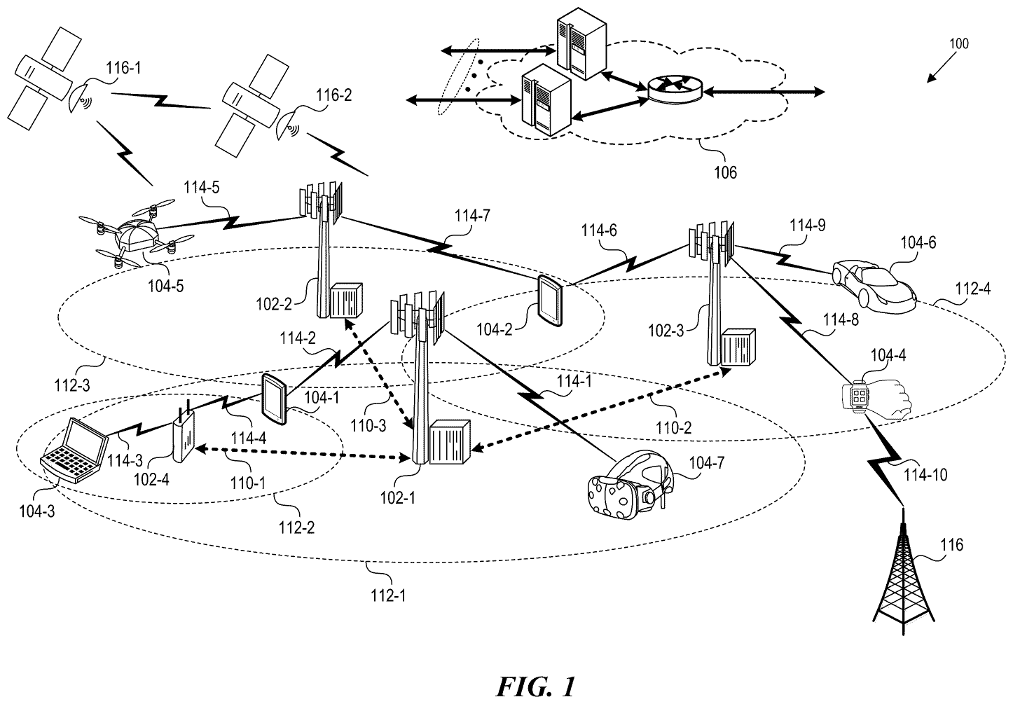

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QOS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

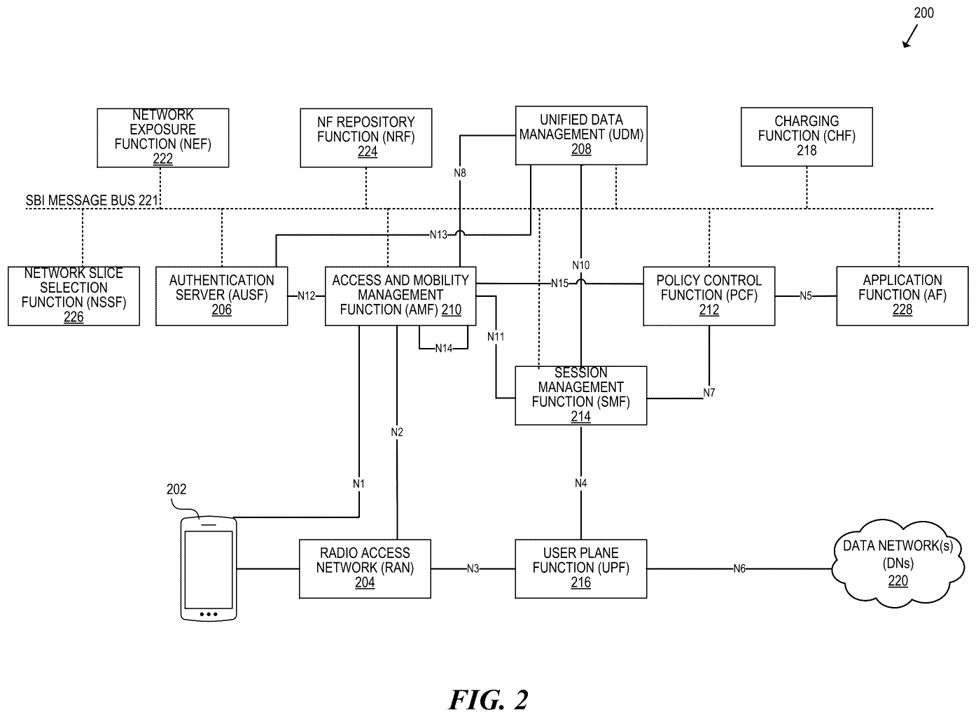

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNS) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a data center, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Dynamic Network Management System

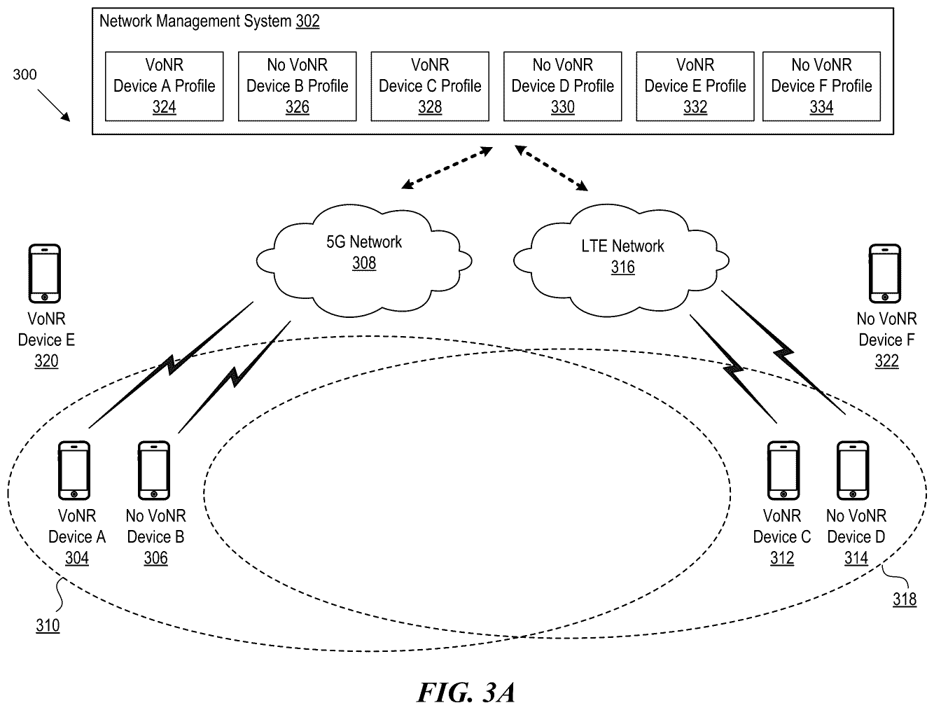

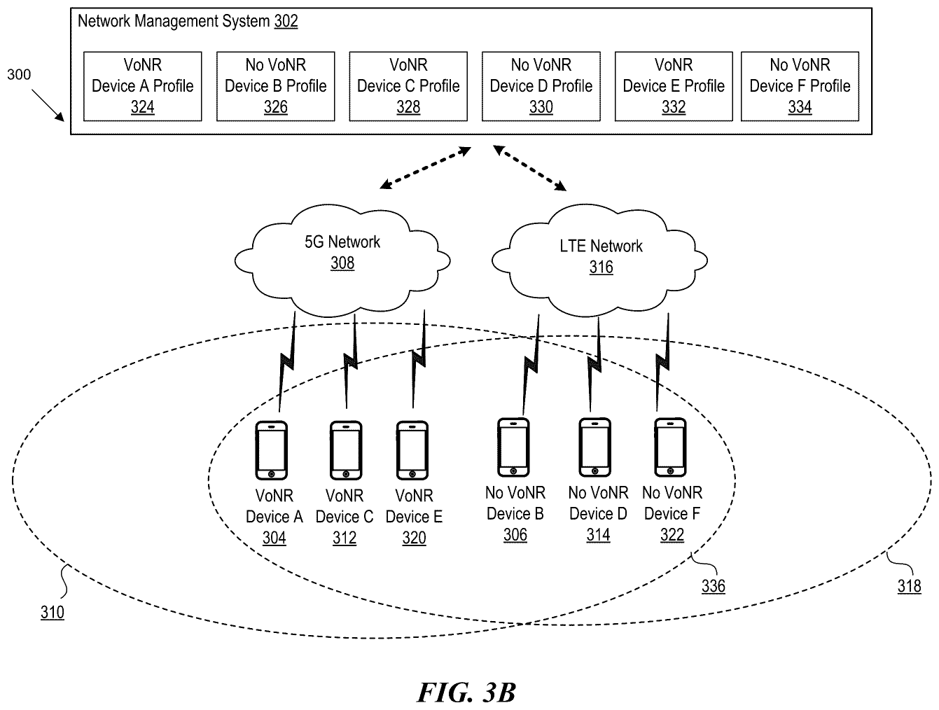

FIG. 3A is a block diagram 300 that illustrates a dynamic network management system used on multiple devices that can implement aspects of the present technology.

User devices are configured to operate within a telecommunications network that includes, for example, a 5G network 308 and an LTE network 316. Devices (e.g., wireless devices) include any electronic device that can communicate and transmit data over the telecommunications network. The devices utilize wireless communication technologies such as Wi-Fi, Bluetooth, cellular networks (e.g., 5G, LTE), infrared, or satellite signals to exchange information with other devices or networks. Examples of wireless devices include smartphones, tablets, laptops, smartwatches, fitness trackers, IoT devices, and various sensors.

Various devices on the telecommunications network can have different capabilities. By way of example, FIG. 3A illustrates a set of devices that have different VoNR capabilities. A device can have VoNR calling capabilities, such as VoNR Device A 304, whereas No VoNR Device B 306 lacks the feature. In some implementations, both the VoNR capable devices and the No VoNR capable devices are configured to communicate other both the 5G network 308 and the LTE network 316, but differ only in their ability to initiate or receive calls using VoNR. Thus, for example, both types of devices are connected to a certain type of network (e.g., 5G network 308), if the 5G network 308 is the sole available network in a first geographic location 310. Similarly, other devices such as VoNR Device C 312 (VoNR capable) and No VoNR Device D 314 (not VoNR capable) are connected to a different type of network (e.g., LTE network 316), because the network is also the only available option in a second geographic location 318. Additionally, in some implementations, certain devices, such as VoNR Device E 320 (VoNR capable) and No VoNR Device F 322 (not VoNR capable), are not connected to any networks due to the current absence in network-covered locations.

Although VoNR capabilities of devices are described herein by way of example, devices within the telecommunications network can have other varying capabilities that affect the ability of a device to perform certain operations on certain types of networks. These capabilities can derive from hardware or software configurations of the devices, user preferences, or external controls such as parental controls, employer restrictions on devices, and/or restrictions imposed by a bill plan or provider. For example, a provider may flag certain roaming partners to restrict certain functions while a user is on the network.

A network management system 302 governs the network preferences of various devices, such as VoNR Device A 304 and No VoNR Device B 306. The network management system 302 maintains individual device service profiles for each device within the network management system's 302 purview. For example, in FIG. 3A, the service profiles encompass Device A's profile 324, Device B's profile 326, Device C's profile 328, Device D's profile 330, Device E's profile 332, and Device F's profile 334. The service profiles serve as repositories of device-specific information for managing network connections and preferences tailored to each device's capabilities and geographical context. Through the service profiles, the network management system 302 determines the network transitions and enhances the overall user experience even when traveling to different geographic locations with different network coverages.

In some implementations, the network management system 302 maintains service profiles based on groups of devices rather than individual devices. The approach allows for more efficient management of network preferences and optimizations across multiple devices with similar characteristics or usage patterns. By grouping devices with one or more common attributes, such as device type, user preferences, and/or geographical location, the system can efficiently store the preferences of a large volume of devices. In some implementations, managing group-based service profiles involves categorizing devices into clusters based on predefined criteria. For example, devices with similar VoNR capabilities, hardware specifications, or usage patterns can be grouped together. Each cluster then represents a distinct user segment with specific network requirements and preferences. The network management system 302 creates service profiles tailored to the characteristics of each cluster, capturing common network preferences and configurations. In some implementations, the network management system 302 implements targeted network resource allocation strategies. By identifying clusters with specific network usage patterns or performance requirements, the system can allocate network resources more effectively to meet the demands of each group. For example, clusters consisting of devices with high bandwidth requirements receive priority access to available network resources during peak usage hours.

FIG. 3B is a block diagram 300 that illustrates a dynamic network management system used on relocated multiple devices that can implement aspects of the present technology.

FIG. 3B presents an extension of the network management system 302 depicted in FIG. 3A, with all devices relocated to a third geographic location 336 that has overlapping coverage of multiple networks, such as 5G network 308 and LTE network 316. Devices categorized as VoNR-capable, such as Device A 304, Device C 312, and Device E 320 coexist in the same geographic area alongside non-VoNR capable devices like Device B 306, Device D 314, and Device F 322, though connected to different networks.

Upon receiving a network registration request from a wireless device, the network management system 302 extracts an identifier to uniquely differentiate between multiple devices. In some implementations, the identifier is the device's International Mobile Equipment Identity (IMEI) identifier. In some implementations, the network management system 302 extracts a Type Allocation Code (TAC) from the IMEI identifier and queries a global database external to the network management system 302 to better determine the device's compatibilities. Using the identifier, the network management system 302 determines the device's compatibility with network technologies such as VoNR and VOLTE. Subsequently, network preferences are generated based on the device's compatibility, ensuring optimal network selection for seamless connectivity.

In some implementations, the generated network preferences prioritize connections within the set of available networks based on device compatibility and predetermined rules within the network management system 302. In some implementations, the prioritizing can be done dynamically, statically, or in a combination of both.

For example, the group of users with VoNR-capable devices, such as Device A 304, Device C 312, and Device E 320, connect to the 5G network 308. The devices, equipped with Voice over New Radio (VoNR) capabilities, automatically prioritize the 5G network 308 over the LTE network 316 due to the device's compatibility with the 5G network 308. As a result, users of Device A 304, Device C 312, and Device E 320 enjoy uninterrupted high-speed data transmission, low latency, and reliable voice calling services afforded by the advanced features of the 5G network. On the other hand, in the same geographical location 336, users with non-VoNR-capable devices such as Device B 306, Device D 314, and Device F 322 connect to the LTE network 316. Despite being within range of the 5G network, the devices lack VoNR support, which triggers the network management system to prioritize the LTE network 316 instead. Thus, users with non-VoNR devices continue to benefit from consistent network connectivity and communication services.

In some implementations, the network management system 302 includes functionality to create and modify service profiles for each wireless device, characterizing their network preferences and adapting to changes in device capabilities or network conditions. Additionally, in some implementations, the network management system 302 maintains a set of records, including allowed networks, unauthorized networks, and/or circumstantial networks, to further refine network selection based on device capabilities or historical performance.

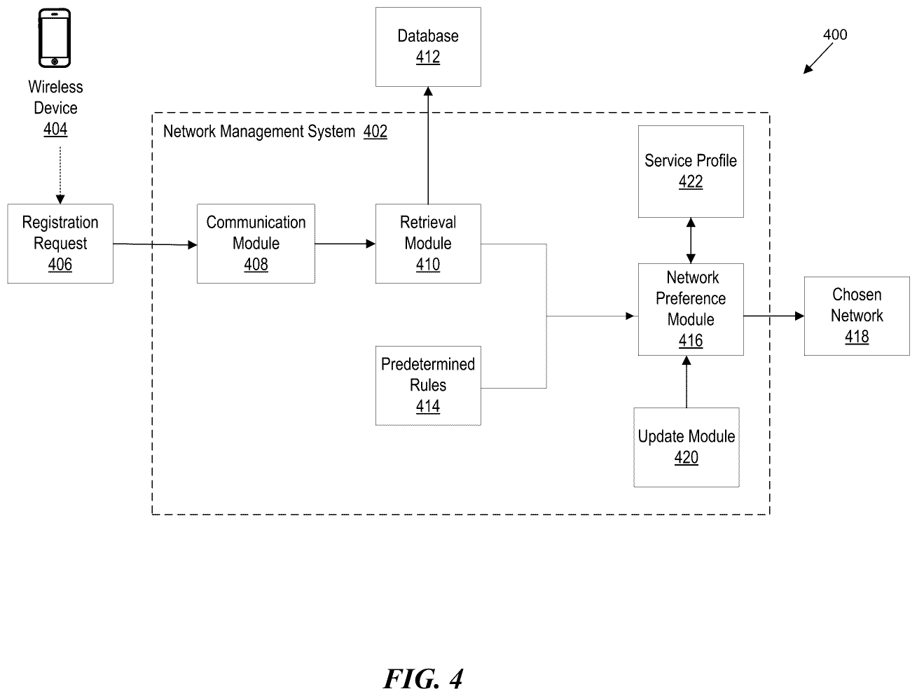

FIG. 4 is a block diagram 400 that illustrates a dynamic network management system used on a single device that can implement aspects of the present technology.

A wireless device 404 sends a network registration request 406. Upon receiving a registration request 406 from the wireless device 404, a communication module 408 within the network management system 402 transmits the network registration request 406 to a retrieval module 410. For example, when a wireless device 404, such as a smartphone, tablet, or IoT device, is powered on or enters a new network coverage area, the device 404 initiates the registration process by sending a network registration request 406 to the network management system 402. The network registration request 406 contains essential information about the device 404, including unique identifiers (such as IMEI, IMSI, or SIM details), network preferences, and capabilities. The network registration request 406 informs the network management system 402 of the device's presence and readiness to connect to the network. By transmitting the registration request 406, the device 404 signals the device's 404 intent to establish communication with the network infrastructure and request allocation of network resources for data transmission, voice calls, or other services. Additionally, the registration request 406 is a means for the network management system to authenticate the device 404, verify the device's 404 eligibility for network access, and enforce network policies and restrictions.

The registration request 406 is then received by a retrieval module 410, which determines the device's 404 capabilities. In some implementations, the retrieval module 410 interacts with a database 412. In some implementations, the retrieval module 410 initiates querying operations against the database 412, which can encompass internal and/or external repositories. The queries are designed to retrieve specific data elements corresponding to the identified device, including hardware specifications, firmware versions, supported communication protocols, and/or network compatibility profiles. For example, data retrieved can include the International Mobile Equipment Identity (IMEI) or other device-specific parameters. In some implementations, the retrieval module 410 utilizes caching mechanisms or indexing techniques to expedite data retrieval.

The network preference module 416 within the network management system 402 then analyzes the available networks and selects a chosen network 418 based on predetermined rules 414, device capabilities, and/or network conditions. In some implementations, the retrieval module 410 parses incoming requests, extracts relevant information, and routes the information to the retrieval module network preference module. The network management system 402 prioritizes between networks within the set of available networks to determine the most suitable network for the wireless device 404 (e.g., by choosing the first prioritized network).

In some implementations, the network preference module 416 employs a rule-based approach, where predetermined rules 414 are established to govern network selection decisions. These rules define criteria and priorities for network selection, taking into account factors such as network type (e.g., 5G, LTE), signal strength, bandwidth availability, latency, and geographical coverage. By adhering to these predefined rules, the network preference module 416 ensures consistent decision-making across different network scenarios with devices having different capabilities. For example, if the device is VoNR-capable, the network preference module 416 prioritizes networks that support VoNR services to provide enhanced voice call quality and reliability. Conversely, if the device lacks VoNR capabilities, alternative network selection criteria can be applied to smoothen the user experience based on available network resources.

In some implementations, the network management system 402 employs dynamic network prioritization algorithms to adaptively select the most suitable network for the wireless device 404 based on real-time network conditions and performance metrics. The algorithms, in some implementations, continuously monitor network parameters, such as signal strength variations, traffic load, and congestion levels, to dynamically adjust network priorities and ensure optimal network utilization and user satisfaction. For example, a wireless device, Device X, with VoNR capabilities, moves between areas with both 5G and LTE coverage. In some implementations, the network management system 402 uses dynamic algorithms to monitor real-time network conditions such as signal strength and congestion. If Device X enters an area with strong 5G coverage and low congestion, the system prioritizes the connection to 5G for faster speeds and lower latency (e.g., taking advantage of the VoNR capabilities). Conversely, if the 5G signal weakens or congestion rises, the system transitions Device X to the LTE network to maintain seamless communication. On the other hand, if a predetermined rule 414 prioritizes minimal network switching, Device X remains on the 5G network.

The predetermined rules 414 take into account various factors, such as the device's capabilities (e.g., VoNR support), user preferences (e.g., prioritizing 5G over LTE for faster speeds), and prevailing network conditions (e.g., network congestion). In some implementations, the network preference module 416 dynamically assigns a preference score to each available network, reflecting the network's suitability for the wireless device 404. The preference score is calculated using weighted criteria based on the predefined rules and/or obtained data. For example, a higher preference score can indicate greater suitability. Once the preference scores are calculated for all available networks, the network preference module 416 selects the network with the highest preference score as the preferred network for the wireless device. Then, the network preference module 416 initiates the necessary network configuration and provisioning processes to establish or switch the wireless device's connection to the chosen network. In some implementations, the network preference module 416 signals the device to perform network registration or handover procedures and/or configure network parameters (such as radio access technology and frequency bands).

In some implementations, a service profile 422 is created to store device 404 information about the wireless device's 404 network preferences and capabilities. The service profile 422 serves as a repository for storing and managing device-specific data, which the network preference module 416 can later reference. In some implementations, upon the wireless device's registration or initial interaction with the network, the network management system 402 dynamically generates a service profile 422 tailored to the device's unique characteristics and requirements. By consolidating relevant information within a single service profile 422, the network preference module 416 easily accesses the parameters used to determine the chosen network 418.

In some implementations, the service profile 422 is updated over time to accommodate changes in the device's 404 capabilities or network preferences. In some implementations, once the chosen network is established, the network management system 402 continuously monitors and analyzes network usage patterns and device behavior for each device and/or group of devices. To ensure the system remains up-to-date with the latest device capabilities and network conditions, in some implementations, an update module 420 provisions updates to the network preference module 416 and service profile 422. The network management system 402 dynamically adjusts the service profiles based on evolving network conditions and user requirements. For instance, if a cluster experiences increased demand for VoNR services or encounters network congestion issues, the system can automatically prioritize other non-congested networks or adjust other parameters accordingly.

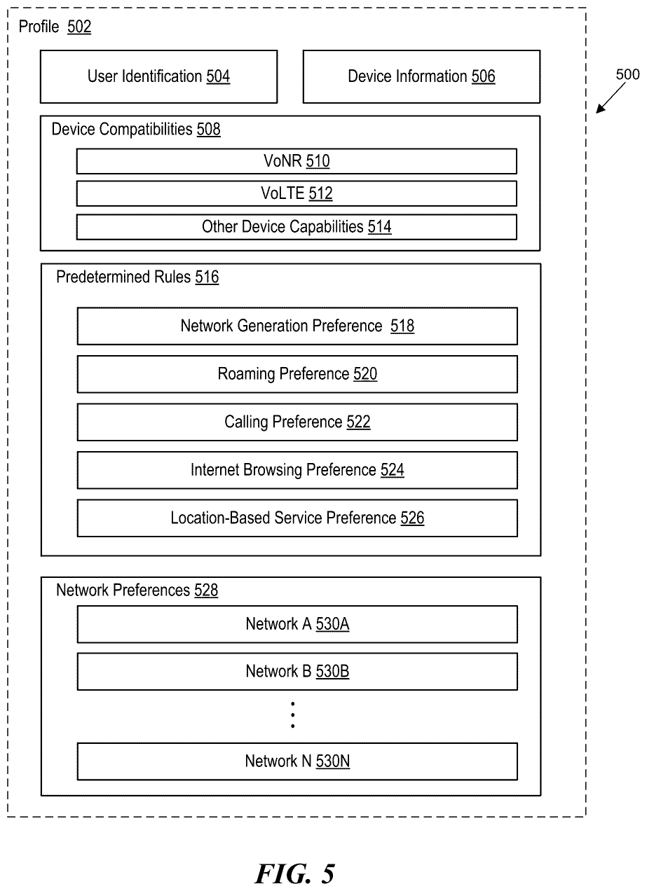

FIG. 5 is a block diagram 500 that illustrates a service profile for a device in a dynamic network management system that can implement aspects of the present technology.

Profile 502, within the network management system, acts as an overall repository to include a variety of types of data that allow the network management system to determine the chosen network. In some implementations, the profile 502 includes user identification 504 details, such as unique identifiers or credentials that allow the network management system to distinguish between specific users of the device. For example, the user identification 504 includes usernames, email addresses, and/or account IDs.

In some implementations, profile 502 includes subscription information, which can encompass various parameters based on the billing plan to which a user has subscribed. The parameters can include the speed of data access, calling abilities, and/or additional services such as call waiting, hold functions, and other supplementary services. The subscription information can be stored in the billing system that maintains records of the user's plan specifics and usage.

In some implementations, device information 506 is within the profile 502 and includes device specifications such as device make, model, hardware capabilities, and software configurations. Device information 506 provides determinations regarding the device's capabilities and limitations, which then enables the network management system to better choose a network suited for the user.

In some implementations, device compatibilities 508, such as VoNR capabilities 510, VOLTE capabilities 512, and other device-specific functionalities 514 are stored within the profile 502. By storing information about a device's VoNR and/or VOLTE capabilities within the profile, the network management system can determine whether the device is capable of making voice calls over 5G networks using VoNR technology. Other device compatibilities 508 to be stored include functionalities that impact network connectivity and performance. For example, support for specific frequency bands, network features (e.g., carrier aggregation, beamforming), multimedia capabilities (e.g., HD video streaming, high-resolution audio), and/or compatibility with emerging technologies (e.g., Internet of Things (IoT) protocols) can be stored to help the network management system choose a network.

In some implementations, a set of predetermined rules 516 governs various network operation preferences. The set of predetermined rules 516 can include rules such as network generation preferences 518, roaming preferences 520, internet browsing preferences 524 (e.g., Wi-Fi, cellular), and/or location-based service preferences 526. The predetermined rules 516 direct the network management system in choosing the network to connect the device to based on the adherence to the predetermined rules.

For example, if the predetermined rules 516 prioritizes 5G connectivity for high-speed data transmission and low latency, the network management system will select a 5G network over LTE or 3G networks when available and compatible with the device's capabilities. Additionally, for example, if the predetermined rules 516 restricts roaming to specific partner networks with favorable roaming agreements, the network management system will prioritize connections to these designated networks while limiting access to non-preferred networks to control roaming costs and ensure network quality. If the predetermined rule prioritizes Wi-Fi networks for data-intensive tasks to conserve cellular data usage, the network management system will prioritize Wi-Fi connections over cellular networks whenever available and feasible. Additionally, for example, if the predetermined rule prioritizes GPS accuracy and responsiveness for location-based applications, the network management system will prioritize connections to networks with strong GPS signal reception and low latency to ensure optimal performance of location-based services.

In some implementations, a set of network preferences 528 tailored to the device's preferences and/or the device's capabilities is stored within the profile 502. For example, preferences and configurations for known networks, such as networks A through N (530A through 530N) in FIG. 5 are ranked in order of connection priority. In some implementations, the set of network preferences 528 is determined based off of user identification 504, device information 506, device compatibilities 508, and/or predetermined rules 516.

In some implementations, the set of network preferences 528 includes historically encountered networks that the device has previously connected to or encountered within specific geographic locations. By analyzing the device's historical network usage history or by updating the service profile 502 each time a network is connected to, the network management system can include the prior networks in the set of network preferences 528. In some implementations, the set of network preferences 528 prioritizes networks that have demonstrated reliability, performance, and user satisfaction in the past.

In some implementations, users or administrators can modify the service profile 502 to adjust network priorities, define chosen networks, and/or specify criteria for network selection (e.g., preferred network types (e.g., Wi-Fi, cellular), preferred operators, preferred network features (e.g., VoNR support)). In some implementations, the network management system has a cache mechanism to store recently accessed or frequently used networks and to remove networks that have not been accessed for a period of time. Previously chosen networks, connection parameters, and/or performance metrics can be stored in profile 502, allowing for quicker retrieval and decision-making during subsequent network registration requests. By caching network preferences, the system can reduce latency with repeated network selection processes. In some implementations, administrators can define global network preference policies, enforce access controls, and apply network prioritization rules consistently across a group of managed devices.

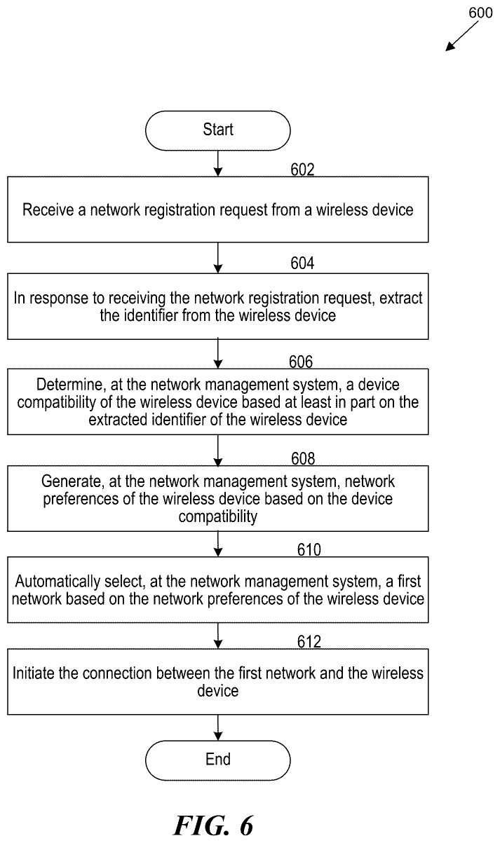

FIG. 6 is a flowchart that illustrates a process 600 performed by a dynamic network management system. In one example, the process 600 is performed by a dynamic network management system (e.g., the dynamic network management system 402 in FIG. 4) to prioritize networks. The process 600 can be performed by a system of a network operator of the telecommunications network (e.g., network 100). More specifically, one or more non-transitory, computer-readable storage media storing instructions recorded thereon that, when executed by at least one data processor of a system of a telecommunications network, cause the system to perform the process 600.

At 602, the network management system receives a network registration request from a wireless device. In some implementations, the wireless device is assigned an identifier (e.g., IMEI number) to differentiate between multiple different wireless devices.

At 604, in response to receiving the network registration request, the network management system extracts the identifier from the wireless device. In some implementations, the identifier is an IMEI identifier. In some implementations, the identifier is a TAC identifier from the extracted IMEI identifier.

At 606, the network management system determines a device compatibility of the wireless device based at least in part on the extracted identifier of the wireless device. In some implementations, the device compatibilities of the wireless device include support for VoNR and/or VOLTE. In some implementations, the network management system queries a global database external to the network management system. The global database includes a set of data compatibilities of multiple wireless devices. The multiple wireless devices include the wireless device.

At 608, the network management system generates network preferences of the wireless device based on the device compatibility. In some implementations, the network preferences are generated by causing the network management system to 1) detect a set of available networks for the wireless device to initiate a connection; and 2) in response to detecting the set of available networks, prioritize between connections within the set of available networks based on the device compatibility and predetermined rules within the network management system.

In some implementations, the instructions for prioritizing the connections within the set of available networks cause the network management system to detect a change in the set of available networks and/or the device compatibilities, or receive a second network registration request from the wireless device. In response to detecting the change or receiving the second network registration request, the network management system generates new network preferences of the wireless device based on the device's compatibilities. The network management system then automatically selects, at the network management system, a second network based on the network preferences of the wireless device. After, the network management system initiates the connection between the second network and the wireless device.

At 610, the network management system automatically selects a first network based on the network preferences of the wireless device. In some implementations, the network preferences are used to generate a prioritized set of available networks, where each network is ranked based on the network's suitability for the device's requirements and current network conditions. In some implementations, the prioritization process considers parameters such as signal strength, network type, latency, and/or historical performance data. In some implementations, networks that best align with the device's preferences and offer more stable connectivity are assigned higher priority rankings. In some implementations, the selection is made based on predefined criteria, such as user preferences.

At 612, the network management system initiates the connection between the first network and the wireless device. In some implementations, the network management system establishes a secure connection between the device and the chosen network. For example, the network management system coordinates the necessary handshakes, authentication procedures, and/or network configurations to facilitate network access for the device.

In some implementations, the network management system creates a service profile for the wireless device characterizing the network preferences and modifies the service profile based on changes in the device compatibilities and/or the network preferences, as described further in FIG. 5.

In some implementations, the network management system maintains a set of records including a set of allowed networks, a set of unauthorized networks, and/or a set of circumstantial networks for an overall set of networks based on the capabilities or historical performance of the overall set of networks. The set of allowed networks includes a first set of networks that grants the wireless device connection. The set of unauthorized networks includes a second set of networks that deny the wireless device connection. The set of circumstantial networks includes a third set of networks that grants the wireless device connection under predetermined circumstances. The network management system then automatically selects the first network based on the network preferences of the wireless device and the set of records.

### Computer System

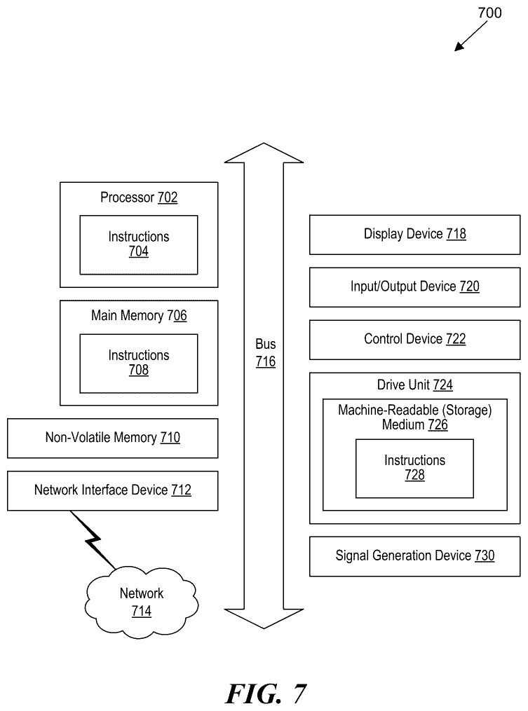

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, a video display device 718, an input/output device 720, a control device 722 (e.g., keyboard and pointing device), a drive unit 724 that includes a machine-readable (storage) medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computing system 700 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 700. In some implementations, the computer system 700 can be an embedded computer system, a system-on-chip (SOC), a single-board computer system (SBC), or a distributed system such as a mesh of computer systems, or it can include one or more cloud components in one or more networks. Where appropriate, one or more computer systems 700 can perform operations in real time, in near real time, or in batch mode.

The network interface device 712 enables the computing system 700 to mediate data in a network 714 with an entity that is external to the computing system 700 through any communication protocol supported by the computing system 700 and the external entity. Examples of the network interface device 712 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 706, non-volatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable medium 726 can include any medium that is capable of storing, encoding, or carrying a set of instructions for execution by the computing system 700. The machine-readable medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computing system 700 to perform operations to execute elements involving the various aspects of the disclosure.

### Remarks

The terms “example” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense-that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number can also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks can be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that can be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. A non-transitory, computer-readable storage medium comprising instructions recorded thereon, wherein the instructions when executed by at least one data processor of a network management system, cause the system to:
receive a network registration request from a wireless device,
wherein the wireless device is assigned an International Mobile Equipment Identity (IMEI) identifier to differentiate between multiple different wireless devices;
in response to receiving the network registration request, extract the IMEI identifier from the wireless device;
determine, at the network management system, a device compatibility of the wireless device based at least in part on the extracted IMEI identifier of the wireless device;
generate, at the network management system, network preferences of the wireless device based on the device compatibility by:
detecting a set of available networks for the wireless device to initiate a connection; and
in response to detecting the set of available networks, prioritizing between connections within the set of available networks based on the device compatibility and predetermined rules within the network management system;
automatically select, at the network management system, a first network based on the network preferences of the wireless device; and
initiate the connection between the first network and the wireless device.

2. The non-transitory, computer-readable storage medium of claim 1, wherein the instructions cause the system to:
create a service profile for the wireless device characterizing the network preferences; and
modify the service profile based on changes in one or more of: the device compatibilities or the network preferences.

3. The non-transitory, computer-readable storage medium of claim 1, wherein the network registration request is a first network registration request, wherein the instructions for prioritizing the connections within the set of available networks cause the system to:
detect a change in one or more of: the set of available networks or the device compatibilities, or receive a second network registration request from the wireless device; and
in response to detecting the change or receiving the second network registration request, generate, at the network management system, new network preferences of the wireless device based on the device compatibilities;
automatically select, at the network management system, a second network based on the network preferences of the wireless device; and
initiate the connection between the second network and the wireless device.

4. The non-transitory, computer-readable storage medium of claim 1, wherein the instructions cause the system to:
extract a Type Allocation Code (TAC) from the extracted IMEI identifier.

5. The non-transitory, computer-readable storage medium of claim 1, wherein the device compatibilities of the wireless device include support for at least one of: Voice over New Radio (VoNR) or Voice over LTE (VOLTE).

6. The non-transitory, computer-readable storage medium of claim 1, wherein the instructions further cause the system to:
maintain a set of records comprising at least one of: a set of allowed networks, a set of unauthorized networks, or a set of circumstantial networks for an overall set of networks based on capabilities or historical performance of the overall set of networks,
wherein the set of allowed networks includes a first set of networks that the wireless device is granted the connection,
wherein the set of unauthorized networks includes a second set of networks that the wireless device is denied the connection, and
wherein the set of circumstantial networks includes a third set of networks that the wireless device is granted the connection under predefined circumstances; and
automatically select, at the network management system, the first network based on the network preferences of the wireless device and the set of records.

7. The non-transitory, computer-readable storage medium of claim 1, wherein the instructions for determining device compatibilities cause the system to:
query a global database external to the network management system,
wherein the global database comprises a set of data compatibilities of multiple wireless devices, and
wherein the multiple wireless devices include the wireless device.

8. A system for dynamically managing network selection of wireless devices comprising:
at least one hardware processor; and
at least one non-transitory memory storing instructions, which, when executed by the at least one hardware processor, cause the system to:
receive a network registration request from a wireless device,
wherein the wireless device is assigned an identifier to differentiate between multiple different wireless devices;
in response to receiving the network registration request, extract the identifier from the wireless device;
determine, at the network management system, a device compatibility of the wireless device based at least in part on the extracted identifier of the wireless device;
generate, at the network management system, network preferences of the wireless device based on the device compatibility,
wherein the network preferences are generated by causing the network management system to:
detect a set of available networks for the wireless device to initiate a connection; and
in response to detecting the set of available networks, prioritize between connections within the set of available networks based on the device compatibility and predetermined rules within the network management system;
automatically select, at the network management system, a first network based on the network preferences of the wireless device; and
initiate the connection between the first network and the wireless device.

9. The system of claim 8, wherein the instructions cause the system to:
create a service profile for the wireless device characterizing the network preferences; and
modify the service profile based on changes in one or more of: the device compatibilities or the network preferences.

10. The system of claim 8, wherein the network registration request is a first network registration request, wherein the instructions for prioritizing the connections within the set of available networks cause the system to:
detect a change in one or more of: the set of available networks or the device compatibilities, or receive a second network registration request from the wireless device; and
in response to detecting the change or receiving the second network registration request, generate, at the network management system, new network preferences of the wireless device based on the device compatibilities;
automatically select, at the network management system, a second network based on the network preferences of the wireless device; and
initiate the connection between the second network and the wireless device.

11. The system of claim 8, wherein the instructions cause the system to:
extract a Type Allocation Code (TAC) from the extracted identifier.

12. The system of claim 8, wherein the device compatibilities of the wireless device include support for at least one of: Voice over New Radio (VoNR) or Voice over LTE (VOLTE).

13. The system of claim 8, wherein the instructions cause the system to:
maintain a set of records comprising at least one of: a set of allowed networks, a set of unauthorized networks, or a set of circumstantial networks for an overall set of networks based on capabilities or historical performance of the overall set of networks,
wherein the set of allowed networks includes a first set of networks that the wireless device is granted the connection,
wherein the set of unauthorized networks includes a second set of networks that the wireless device is denied the connection, and
wherein the set of circumstantial networks includes a third set of networks that the wireless device is granted the connection under predefined circumstances; and
automatically select, at the network management system, the first network based on the network preferences of the wireless device and the set of records.

14. The system of claim 8, wherein the instructions for determining device compatibilities cause the system to:
query a global database external to the network management system,
wherein the global database comprises a set of data compatibilities of multiple wireless devices, and
wherein the multiple wireless devices include the wireless device.

15. A method for dynamically managing network selection of wireless devices comprising:
receiving, at a network management system, a network registration request from a wireless device,
wherein the wireless device is assigned an identifier to differentiate between multiple different wireless devices;
in response to receiving the network registration request, extracting the identifier from the wireless device;
determining, at the network management system, a device compatibility of the wireless device based at least in part on the extracted identifier of the wireless device;
generating, at the network management system, network preferences of the wireless device based on the device compatibility,
wherein the network preferences are generated by causing the network management system to:
detect a set of available networks for the wireless device to initiate a connection; and
in response to detecting the set of available networks, prioritize between connections within the set of available networks based on the device compatibility and predetermined rules within the network management system;
automatically selecting, at the network management system, a first network based on the network preferences of the wireless device; and
initiating the connection between the first network and the wireless device.

16. The method of claim 15, wherein the method further comprises:
creating a service profile for the wireless device characterizing the network preferences; and
modifying the service profile based on changes in one or more of: the device compatibilities or the network preferences.

17. The method of claim 15, wherein the network registration request is a first network registration request, further comprising:
detecting a change in one or more of: the set of available networks or the device compatibilities, or receive a second network registration request from the wireless device; and
in response to detecting the change or receiving the second network registration request, generating, at the network management system, new network preferences of the wireless device based on the device compatibilities;
automatically selecting, at the network management system, a second network based on the network preferences of the wireless device; and
initiating the connection between the second network and the wireless device.

18. The method of claim 15, wherein the device compatibilities of the wireless device include support for at least one of: Voice over New Radio (VoNR) or Voice over LTE (VOLTE).

19. The method of claim 15, further comprising:
maintaining a set of records comprising at least one of: a set of allowed networks, a set of unauthorized networks, or a set of circumstantial networks for an overall set of networks based on capabilities or historical performance of the overall set of networks,
wherein the set of allowed networks includes a first set of networks that the wireless device is granted the connection,
wherein the set of unauthorized networks includes a second set of networks that the wireless device is denied the connection, and
wherein the set of circumstantial networks includes a third set of networks that the wireless device is granted the connection under predefined circumstances; and
automatically selecting, at the network management system, the first network based on the network preferences of the wireless device and the set of records.

20. The method of claim 15, further comprising:
querying a global database external to the network management system,
wherein the global database comprises a set of data compatibilities of multiple wireless devices, and
wherein the multiple wireless devices include the wireless device.
